(19) United States
(12) Patent Application Publication
(10) Pub. No.: US 2004/0069575 A1
(43) Pub. Date: Apr. 15, 2004

(54) Independent springing guides for floating rotors

(75) Inventors: Paul J Mura, Macomb, MI (US); Richard J. Kowalczyk, Novi, MI (US); Keith W. Deyer, Birmingham, MI (US)

Correspondence Address: Scott A. McBain, DELPHI TECHNOLOGIES, INC., Legal Staff, Mail Code: 480-414-420, P.O. Box 5052, Troy, MI, 48007-5052, US

(73) Assignee: DELPHI TECHNOLOGIES, INC.

(21) Appl. No.: 10/269,496

(22) Filed: Oct. 11, 2002

(51) Int. Cl. B60T 1/06

(52) U.S. Cl. 188/18 A

(57) ABSTRACT

A disc brake assembly includes a rotatable hub and at least one disc supported on the hub for rotation therewith about an axis, and slideable axially along the hub. A guide member is disposed between the hub and disc. A spring member is separately formed from the guide member and acts between the guide member and the hub to impart a constant radial force against the guide member and thus the disc in such manner as to position the guide member in constant engagement with the disc to maintain alignment and prevent rattling of the disc on the hub.

### TECHNICAL FIELD

The invention relates generally to disc brake assemblies having discs that slide axially along a hub, and more particularly to disc brake assemblies having discs that slide axially along a hub and have a preload device between the discs and the hub.

### BACKGROUND OF THE INVENTION

It is known for disc brake assemblies to have two discs to improve the braking efficiency of a vehicle. Further, it is known to have the two discs axially slideable relative to a hub of the assembly. In providing for discs that are axially slideable along a hub, the discs generally have a clearance fit relative to the hub, and thus are able to tilt from perpendicular relative to an axis of the hub. Copending U.S. application Ser. No. 09/762,831, which is commonly owned by the assignee of the present invention, discloses use of leaf springs which are bolted to the hub and have integral guide portions or embossments which slideably support the discs. The leaf springs have integral spring portions which act to apply radially directed spring force to the discs to control tilting movement of the discs. While such leaf springs are effective in controlling tilting of the discs on the hub, there is no provision for adjusting the amount of force or preload applied by the leaf springs to the discs.

A disc brake assembly construction according to the present invention overcomes or greatly minimizes the above limitations of prior disc brake assemblies.

### SUMMARY OF THE INVENTION

A disc brake assembly constructed according to a presently preferred embodiment of the invention has a hub with an axis of rotation and at least one disc disposed on the hub for conjoint rotation therewith about the axis, while being axially slideable along the hub. At lease one guide member is disposed between the hub and the disc wherein the disc is axially slideable relative to the guide member. At least one spring member is disposed between the guide member and the hub to impart a radial force on the guide member urging it into constant engagement with the disc to maintain alignment of the disc and to prevent the disc from rattling on the hub.

One advantage of the invention is that a preload of the guide member is established by the spring device acting between the hub and disc that is readily adjustable by changing the spring device used.

Another advantage of the invention is that a uniform preload is established between a guide member and a disc to maintain the disc in a proper orientation relative to the hub.

Another advantage of the invention is that no fasteners are required in a preferred embodiment of the invention in order to support the disc against rattling and misalignment, thus reducing the cost and improving the simplicity of such disc brake assemblies.

### BRIEF DESCRIPTION OF THE DRAWINGS

The present invention will now be described, by way of example, with reference to the accompanying drawings, in which:

FIG. 1 is a partial cross-sectional elevation view of a disc brake assembly according to a first embodiment of the invention;

FIG. 2 is an enlarged fragmentary cross-sectional view of the assembly of FIG. 1;

FIG. 3 is an enlarged fragmentary cross-sectional view taken generally along lines 3-3 of FIG. 2;

FIG. 4 is a view like FIG. 2 but of an alternative second embodiment of the invention;

FIG. 5 is an enlarged fragmentary cross-sectional view taken generally along lines 5-5 of FIG. 4;

FIG. 6 is a fragmentary cross-sectional view of a third embodiment of the invention;

FIGS. 7A-C are isometric views of three alternative spring devices of the invention; and

FIG. 8 is an isometric view of a presently preferred embodiment of a guide member of the invention.

### DESCRIPTION OF THE PREFERRED EMBODIMENT

Referring initially to FIGS. 1-3, a disc brake assembly 10 has at least one disc, and preferably two discs 12, 13 disposed on a hub 14, having an axis 16 of rotation. The discs 12, 13 are supported for axial sliding movement along the hub 14 in the direction of the axis 16, but also engage the hub 14 in a manner that supports the discs 12, 13 for rotation with the hub 14 about the axis 16. At least one guide member 18 is received between the hub 14 and the discs 12, 13 and slideably support the discs 12, 13 for movement along the hub 14. At least one spring member 20 is received between the guide member 18 and the hub 14 to impart a radial force between the guide member 18 and the hub 14 to maintain the guide member 18 in constant engagement with the discs 12, 13 to align and prevent rattling of the discs 12, 13 against the hub 14.

The disc brake assembly 10 has a non-rotatable support structure 22 supporting a plurality of friction elements or brake pads for relative axial movement into and out of frictional braking engagement with the brake pads. The non-rotatable support structure 22 comprises a knuckle portion 24, a bridge portion 26, and an end plate portion 28. The knuckle portion 24 has an opening 30 formed in an extension 32 of the knuckle portion 24 for receiving a strut (not shown) and the opening 30 has an axis 34 about which the disc brake assembly 10 pivots for a vehicle. Another opening 36 is formed in a lower extension 38 of the knuckle portion 24 for receiving a pin of a ball joint on a tie bar (not shown). An arm 40 extends laterally from the knuckle portion 24 and has an opening 42 adjacent an end 44 of the arm 40 for receiving a track bar (not shown) for rotation of the disc brake assembly 10 about the axis 34. A generally cylindrical piston chamber 46 is formed in the knuckle portion 24 for receiving a piston 48 for reciprocating movement therein. The piston 48 is disposed adjacent a sliding brake pad assembly which is supported by the bridge portion 26. Preferably, a plurality of brake assemblies including an axially inner pad assembly 50, an intermediate pad assembly 52 and an outer pad assembly 54 are provided. Axial movement of the piston 48 toward the discs 12, 13 slides the brake pad assemblies 52, 54, 56 and discs into frictional braking engagement with one another. Releasing the piston releases the braking action of the brake pad assemblies 52, 54, 56 and discs 12, 13.

The bridge portion 26 of the disc brake assembly 10 has an end 56 spaced from the knuckle portion 24 and preferably a pair of threaded fastener openings (not shown) in which fasteners 58 are disposed for fastening the bridge portion 26 to the knuckle portion 24. A top surface 60 of the bridge portion 26 preferably has a pair of fastener openings (not shown) in which a pair of fasteners 64 are disposed for fastening a spring device 62 to the top surface 60 of the bridge portion 26. The bridge portion 26 has a pair of opposite sides 66 presenting an axial slideway 68 along which the brake pad assemblies 50, 52, 54 slide.

The brake pad assemblies 50, 52, 54 have friction elements or brake pads 70 fixed thereto and are slideably supported by the slideway 68 of the bridge portion 26 for relative axial movement along at least a portion of the bridge portion 26. When an actuator (not shown) is actuated, the piston 48 moves the brake pads 70 to slide into frictional engagement with the discs 12, 13 as previously described. The spring device 62 exerts a radial force on the brake pad assemblies 50, 52, 54 to support them against rattling on the bridge portion 26.

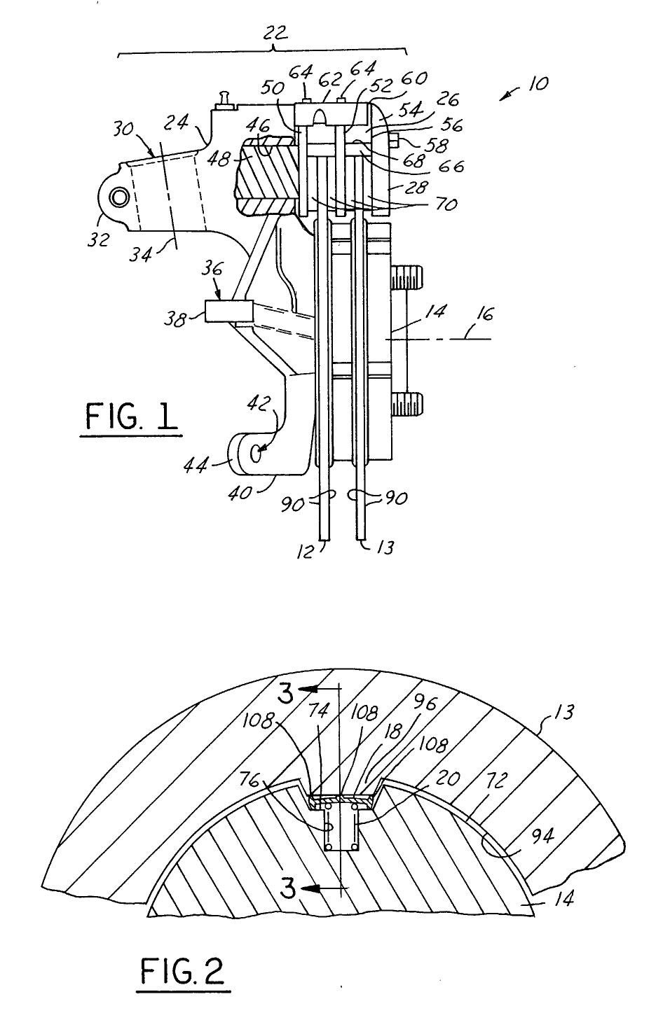

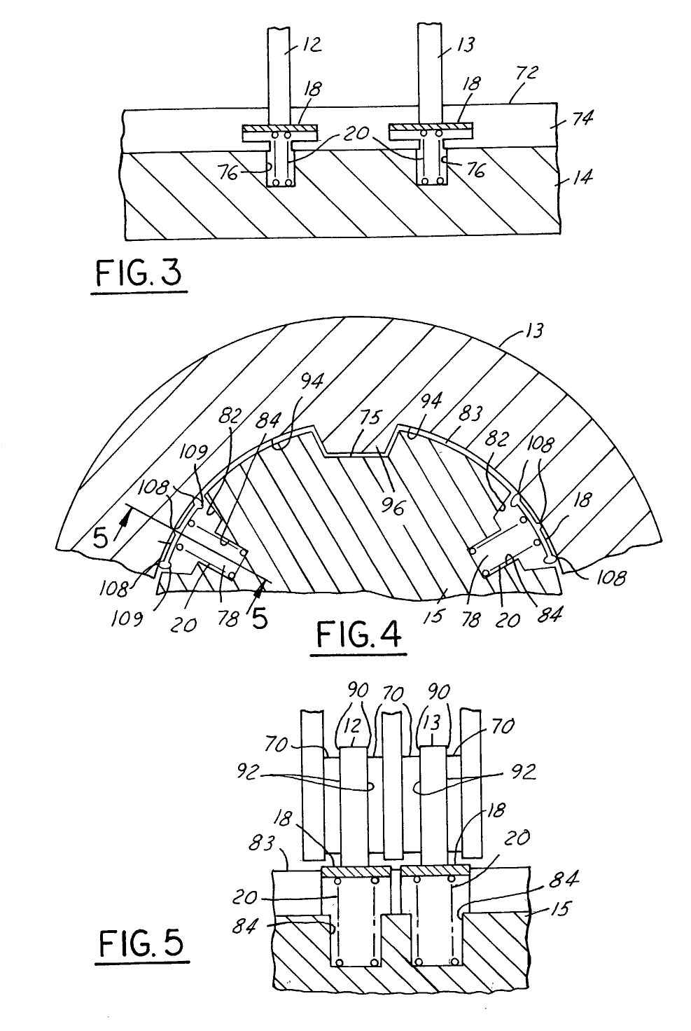

The hub 14 is generally cylindrical and has an outer surface 72 with a plurality of axial slots or grooves 74 extending radially inwardly from the outer surface 72 and axially between opposite ends of the hub 14. At least one and preferably a pair of spring pockets or cavities 76 extend radially inwardly from the grooves 74, with the grooves extending across the cavities 76. The cavities 76 receive the associated spring devices 20, and thus the shape and size of the cavities 76 conform closely to that of the received portions of the spring devices 20. The cavities 76 of the first embodiment illustrated best in FIGS. 2 and 3 are generally cylindrical in shape to receive the spring members 20 which preferably are coil compression springs 78. In an alternate embodiment illustrated in FIGS. 4 and 5, a hub 15 having a groove or plurality of grooves 75 for receiving and axially guiding the discs 12, 13 are radially offset and separate from a plurality of recesses 82 extending inwardly from an outer surface 83 of the hub 15. A plurality of spring pockets or cavities 84 extend radially inwardly from the recesses 82 to accommodate associated spring members 78 and guide members 18, respectively.

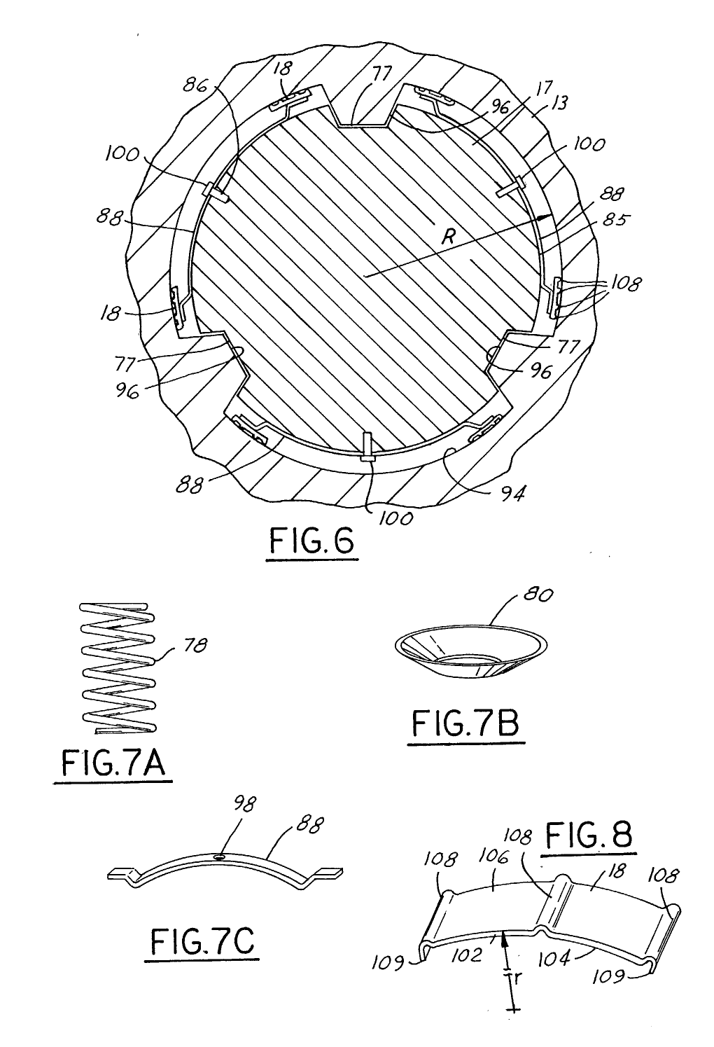

FIG. 6 illustrates a further embodiment in which a hub 17 has a groove or plurality of grooves 77 extending radially inwardly from an outer surface 85 of the hub 17 and preferably spanning an axial width of the hub 17. A fastener opening 86 is formed between adjacent pairs of the grooves 77 for mounting leaf springs 88, fastened to the outer surface 85 of the hub 17 between each pair of grooves 77. The fastener openings 86 are preferably positioned midway between the grooves 77.

The discs 12, 13 have opposite sides 90 presenting braking surfaces 92 on which the brake pads 70 move into and out of frictional engagement. The discs 12, 13 have a bore 94 with an internal diameter of radius R, and have projections or teeth 96 extending radially inwardly from the bore 94. The discs 12, 13 are disposed on the hubs 14, 15, 17 so that the bore 94 is adjacent the outer surfaces 72, 83, 85, respectively, and the teeth 96 are received in the grooves 74, 75, 77, respectively. The teeth 96 slide axially with the discs 12, 13 along while interlocking with a spine action with the grooves 74, 75, 77 in the circumferential direction to support the discs 12, 13 for rotation with the hub 14, 15, 17.

As illustrated best in FIGS. 7A-C, the spring member 20 can take on a variety of configurations in the various embodiments of the invention. All are separate from the guide member 18 and in the same general way they achieve the same general result of supporting the discs 12, 13 against rattling and maintaining their alignment on the hub 14, 15, 17. FIG. 7A illustrates the coil-type compression spring 78 that is preferably used in conjunction with the cavity 76. FIG. 7B shows a Belleville or spring-type washer 80 that is preferably used in conjunction with the cavity 76 in the same manner as the spring 78. FIG. 7C illustrates a leaf-type spring 88 formed with a through hole 98 so that a fastener 100 may be used to attach the leaf spring 88 to a hub 17 as illustrated in FIG. 6. The leaf spring 88 does not require a cavity to be formed in the hub 17, and can be attached directly to the outer surface 85 of the hub 17.

Regardless of which style of spring member 20 is used, the amount of radial force imparted by the spring member 20 is dependent upon the individual spring properties or spring constant of the spring member 20. Therefore, depending on the requirements of the specific vehicle application, the appropriate spring member 20 can be selected to meet the particular requirements of the application.

As shown in FIG. 8, the guide member 18 is generally arcuate in shape, having arcuate side surfaces 102, an arcuate concave inner surface 104 and an arcuate convex outer surface 106. The outer surface 106 preferably has a radius of curvature, r, that complements and is preferably generally the same as the radius of curvature R of the bore 94 of the discs 12, 13. In this way, the guide member 18 is isolated from acting on its own as a spring device, and must rely on the action of the separate spring devices described above. An abutment or preferably a plurality of abutments or ridges 108 extend radially outwardly from the outer surface 106. The ridges 108 are arranged so that upon assembly of the guide member 18 to the hub 14, 15, 17. Preferably, a pair of tabs 109 extend radially inwardly from the ends of the guide member 18 to maintain the guide member 18 within the recess 82, as shown in FIG. 4. The guide member 18 can be of a length to guide a single disc, or the guide member 18 can be of a length to guide multiple discs.

Upon actuation of the brake pads 70 into and out of frictional engagement with the discs 12, 13, the discs 12, 13 move relative to the hub 14, 15, 17 along the axis 16 of the hub 14, 15, 17. Throughout the relative axial movement of the discs 12, 13, the guide members 18 remain in constant contact with the discs 12, 13 to prevent the discs 12, 13 from rattling or tilting relative to the hub 14, 15, 17. The ridges 108 on the guide members 18 provide line contact with the teeth 96 of the discs 12, 13, as shown in FIGS. 2 and 3, or with the bore 94 of the discs 12, 13, as shown in FIGS. 4-6 to facilitate slideable movement of the discs 12, 13 along the ridges 108, while also maintaining the discs 12, 13 in a generally perpendicular orientation relative to the axis 16. By maintaining the discs 12, 13 in a generally perpendicular and non-tilted orientation, braking efficiencies facilitated by uniform engagement of the brake pads 70 with the braking surfaces 92 of the discs 12, 13 are improved.

The spring members 20 remain at least partially compressed at all times between the hub 14,15, 17 and the guide members 18 to provide a constant preload and to facilitate constant engagement of the guide members 18 with the discs 12, 13.

As shown in FIGS. 2 and 3, when the guide members 18 are inserted within the grooves 74 of the hub 14, the guide members 18 are displaced by the teeth 96 of the discs 12, 13 radially inward of the outer surface 72 of the hub 14. Such displacement of the guide members 18 is achieved by compression of the spring members 20, thus creating the constant radial preload between the discs and the hub 14. Alternatively, when the guide members 18 are positioned in a recess 82 separate from the grooves 74, as shown in FIGS. 4 and 5, the ridges 108 preferably remain radially outward of the outer surface 83 of the hub 15 to contact the bore 94 of the discs 12, 13. Alternatively, when the guide members 18 are used in combination with the leaf spring 88, as shown in FIG. 6, the ridges 108 remain radially outward of the outer surface 85 of the hub 17 to contact the bore 94 of the discs 12, 13. It should be recognized that the preload between the hub 14, 15, 17 and the discs 12, 13 is preferably imparted entirely by the spring devices 20 and not influenced by the guide members 18. This is facilitated by the complemental arcuate shape and size of the guide members 18 relative to the bore 94 of the discs 12, 13 as previously described.

Obviously, many modifications and variations of the present invention are possible in light of the above teachings. It is, therefore, to be understood that within the scope of the appended claims, the invention may be practiced otherwise than as specifically described. The invention is defined by the claims.

1. A disc brake assembly, comprising:
a hub having an outer surface and an axis of rotation;
at least one disc disposed on said hub for rotation therewith about said axis and for relative axial sliding movement along said hub;
at least one guide member disposed between said hub and said at least one disc and slideably engaging said at least one disc for relative movement therewith along said axis; and
at least one spring member formed as a separate piece from said at least one guide member and acting between said at least one guide member and said hub to impart a constant radially outward spring force on said at least one guide member to maintain said at least one guide member in constant engagement with said at least one disc.

2. The disc brake assembly of claim 1 wherein said at least one guide member has a recess on a back side thereof in which said at least one spring member extends.

3. The disc brake assembly of claim 1 wherein said hub has a cavity extending radially inwardly from said outer surface and said at least one spring member is disposed in said cavity between said hub and said at least one guide member.

4. The disc brake assembly of claim 3 wherein said cavity conforms generally to the shape of said at least one spring member to maintain said at least one spring member with said cavity.

5. The disc brake assembly of claim 3 wherein said hub has a recess radially outward from said cavity for receiving and maintaining said at least one guide member within said recess.

6. The disc brake assembly of claim 5 wherein said at least one guide member has a pair of tabs extending radially inwardly and into said recess.

7. The disc brake assembly of claim 3 wherein said hub has at least one groove extending radially inwardly from said outer surface and axially in the direction of said axis and said at least one disc includes at least one projection extending radially inwardly into said at least one groove and for axial sliding movement therealong and to support said at least one disc for conjoint rotational movement with said hub.

8. The disc brake assembly of claim 7 wherein said at least one groove extends across said cavity.

9. The disc brake assembly of claim 8 wherein said at least one guide member is compressed by said at least one projection of said at least one disc radially inwardly of said outer surface of said hub and compressing said at least one spring member within said cavity to provide a constant radial preload between said at least one disc and said hub.

10. The disc brake assembly of claim 7 wherein said at least one groove is radially offset from said cavity.

11. The disc brake assembly of claim 10 wherein said at least one guide member is supported at least partially radially outwardly from said outer surface of said hub while compressed by said at least one disc to impart a constant radial preload between said at least one disc and said hub.

12. The disc brake assembly of claim 1 wherein said at least one spring member comprises a coil spring.

13. The disc brake assembly of claim 1 wherein said at least one spring member comprises a leaf spring.

14. The disc brake assembly of claim 1 wherein said at least one spring member comprises a spring washer.

15. The disc brake assembly of claim 1 wherein the radial force between said at least one guide member and said hub has a magnitude determined entirely by said at least one spring member and independently of said at least one guide member.

16. The disc brake assembly of claim 1 wherein said at least one guide member has a surface with a radius of curvature and said at least one disc has a bore with a radius of curvature, said radius of curvature of said surface being generally the same as said radius of curvature of said bore while in an unassembled state to isolate said at least one guide member from contributing to said radial force.

17. The disc brake assembly of claim 1 wherein said at least one guide member includes at least one axially extending abutment disposed in said constant engagement with said at least one disc.

18. The disc brake assembly of claim 17 wherein said at least one axially extending abutment is formed integrally as one piece with said at least one guide member.

19. The disc brake assembly of claim 1 wherein there are a plurality of said discs, a plurality of said guide members, and a plurality of said spring members.
